(19) United States
(12) Patent Application Publication
(10) Pub. No.: US 2012/0214014 A1
(43) Pub. Date: Aug. 23, 2012

(54) METHOD FOR PRODUCING A COMPOSITE PART

(76) Inventors: Rainer Schmitt, Wachtberg (DE); Frank Sablotny, Bornheim (DE)

(21) Appl. No.: 13/427,223

(22) Filed: Mar. 22, 2012

Related U.S. Application Data
(63) Continuation of application No. PCT/EP2010/005524, filed on Sep. 8, 2010.

(30) Foreign Application Priority Data
Sep. 23, 2009 (DE) 10 2009 042 603.5

(51) Int. Cl. B22F 7/04; B32B 15/00; B32B 5/16; B22F 3/12

(52) U.S. Cl. 428/553; 419/66; 419/8; 425/78; 428/457; 428/161

(57) ABSTRACT

The invention relates to a method for producing a composite part, the composite part comprising at least one powder metal part compacted from a powdery material and at least one solid part. The powdery material is compacted to a powder metal part inside the working chamber of a press, especially a pressing tool of a press, and the solid part is at least partially fed to the working chamber in the same step, especially in the same working cycle of the press so that the composite part is produced within one working cycle.

### CROSS-REFERENCE TO RELATED APPLICATIONS

This application is a continuation application of PCT application serial number PCT/EP2010/005524 entitled “Method for Producing a Composite Part” filed on Sep. 8, 2010 which claims priority to German patent application number 10 2009 042 603.5 filed on Sep. 23, 2009. The contents of both of these applications are incorporated by reference as if set forth in their entirety herein.

### BACKGROUND

The present invention relates to the production of a composite part.

Japanese Patent Specification 2000-144212 discloses a method in which a cam disc is molded from a green compact and sintered. Prior to sintering, a coupling element is incorporated in the green compact and sintered along with the latter in order to join the coupling element to the sintered part.

### SUMMARY

The object of the present invention is to provide a method with which to produce a composite part in a rapid and cost-effective manner.

The object is achieved according to the present invention by a method, a press, the use of a press, a computer program product and a composite green compact such as those that are found in the claims.

A method for producing a composite part is proposed in which the composite part comprises at least one powder metal part and at least one solid part. A powdery material is compacted to form the powder metal part inside the working chamber of a press, especially a pressing tool of a press. The solid part is at least partially fed to the working chamber in the same step, especially in the same working cycle of the press so that the composite part is produced within one working step. A powdery material is defined herein, in particular, as a powder metal. Furthermore, a solid part may be comprised of a metal or ceramic material. For example, a solid part may be comprised of a cast, drawn, sintered, rolled, forged and/or extruded—in particular—pultruded material. One working step of the press encompasses a working cycle and a return cycle, wherein during the working cycle the press closes, then opens again during the return cycle. The working step may optionally also include a downtime, in which the press or the pressing tool remains in one position between the working and return cycles for a defined period of time.

In a first embodiment, it is provided in a first step of the working cycle to add the solid part to the powdery material in the working chamber and in a second step to compact the powdery material to form a powder metal part or a green compact. In another embodiment it is provided in a first step of the working cycle to compact the powdery material within the working chamber to form a green compact and in a second step to feed the solid part to the green compact in the working chamber. Preferably, an embodiment is provided in which the solid part is fed to the working chamber while the powdery material is being compacted to form a green compact.

The term green compact is used in the following to mean an un-sintered, powder metal part compacted from a powdery material. A powder metal part is defined, in general, as a green compact, a sintered body and/or sintered part.

For example, the solid part and the powdery material may be comprised of the same alloy. In other embodiments, it is provided that the powdery material and the solid part are comprised of different alloys. In particular, it is provided that the powdery material comprises a metal powder and the solid part a non-metallic material, for example, a ceramic. In another embodiment, the powdery material can also include a ceramic powder and the solid part may include a ceramic or non-ceramic material. Thus, a powder metal part can also mean a part that also includes a non-metallic material, in particular one comprising no metallic material. In one embodiment, it is also provided that the solid part and the powdery material are comprised of different metal alloys or ceramic alloys. Alloys may be defined herein as metal alloys or ceramic mixes, as well as pure metals or ceramics.

In still a further embodiment, it is provided that the solid part is transferred into the work chamber in such a way that, after the work cycle, the solid part protrudes from a surface of the green compact or of the powder metal part. In a further embodiment, the solid part ends with at least one face of the powder metal part. In particular, it is provided in one embodiment that an oversize of the solid part protrudes from a surface of the powder metal part. In still a further embodiment, it is provided that the solid part ends with an undersize below a surface of the powder metal material. Over- or undersizes of approximately 0.001 millimeters to approximately 15 millimeters, in another embodiment up to about 20 centimeters, are provided.

In a further variant, the solid part is surface-treated, preferably prior to being introduced into the press. In particular, a specific portion of the surface is provided with an increased roughness. Preferably, at least a portion of the surface of the solid part has an average roughness of Rz=1 μm to Rz=63 μm. Roughness is defined as a form deviation of the third to the fifth order in surfaces in accordance with DIN 4760. It is especially preferred if a portion of the surface of the solid part is oxidized or coated with a conversion layer, for example, burnished or phosphated.

In another embodiment, it is provided that a metal oxide layer is generated on the, in particular, metallic solid part by means of steam treatment. The latter is carried out at temperatures of, in particular, about 500° C. to 570° C. Preferably, steam treatment of the solid part is carried out for at least 10 minutes, preferably for at least 30 minutes. It is also preferable to produce an oxide layer with a thickness of at least 2 μm. The advantage of this is that the powder particles of the powdery material are able to bond more efficiently to the surface of the solid part. Furthermore, the advantage of an oxide layer is that said layer is reduced again during sintering and that, in particular, improved sintering between the powder particles and the solid part can be achieved. In a further embodiment, the surface is mechanically treated, for example, roughened by grinding or coarsing/roughing processes. Another variant provides that the surface is smoothed, for example, polished.

The composite part, once removed from the press, for example, is sintered and/or pre-sintered in order to convey it to additional working steps, if necessary. In another embodiment, it is provided that the composite part is sinter-forged.

A further concept of the present invention involves a press for compacting and joining a composite part, wherein the press comprises a working chamber and at least one press punch and at least one joining punch. In particular, in one embodiment, the press also includes at least one transfer punch. Preferably, a powdery material is fed into the working chamber, wherein in said chamber a green composite can be compacted from the powdery material using a press punch. In a further embodiment, it is provided that a solid part can be transferred into the working chamber using the joining punch and/or the transfer punch. In particular, the solid part is fed, at least in part, to the powdery material or the green composite; for this, a further embodiment provides that a joining space is reserved by means of the transfer stamp in the working chamber into which space the solid part can be transferred, preferably along with the joining punch. In particular, the joining space is at least partially defined by the powdery material fed into the working chamber.

In one embodiment, the press includes a control device, wherein said control device controls the transfer of the solid part into the working chamber. In particular, a computer program product is implemented in the control device such that the transfer punch is controlled in such a way as to reserve a joining space in the working chamber, which space is at least partially filled in with a powdery material and into which a solid part is transferred using the joining punch and/or transfer punch. The powdery material which partially fills in the joining space borders, preferably at least partially, precisely on the joining punch and thus on the joining space. In particular, it is provided that, when the solid part is transferred into the joining space, the powdery material fills at least in part the joining space, which is preferably not filled in by the solid part. In a further embodiment, provision is made for introducing the solid part into the powdery material by means of the joining punch, whereby the solid part, as it is submerged in the powdery material, displaces the latter. In this embodiment, a transfer stamp for keeping the joining space clear is not required.

A further concept of the present invention involves the use of the aforementioned press for an aforementioned method.

A further concept of the present invention involves a computer program product for a press having a tool, wherein the tool comprises a working chamber and at least one pressing punch, as well as at least one joining punch, whereby a process is implemented in said computer program product to control the joining punch in such a way as to transfer a solid part into a working chamber that is filled at least partially with a powdery material. In a first embodiment, it is provided that a transfer punch is controlled in such a way as to reserve a joining space in the working chamber, which space is filled in at least partially, in particular, with a powdery material that is to be compacted and into which a solid part is transferred using the joining punch. In one embodiment, in particular, it is provided that once the solid part has been transferred into the joining space, the pressing punch is actuated in order to compact the powdery material to form a green composite. In a further embodiment, it is provided that the pressing punch is actuated to compact the powdery material to form a green composite, before the solid body is transferred into the joining space. Preferably, the computer program product controls a compaction step and a joining step simultaneously. In this connection, the term “control” is understood to mean actuating using a control without feedback, as well as regulating using a control with feedback. Preferably, the joining punch and/or the transfer punch are moved using a path control or a distance control. A further embodiment provides that the pressing punch is actuated such as to apply a predefined force to the powdery material or to perform predefined work on the powdery material. The input data are determined, for example, by a user or press tool setter, preferably as a function of the properties exhibited by the green composite or the composite green composite. In a further embodiment, the pressing punch is moved using a path or distance control.

A further concept of the present invention involves a composite part comprising at least one green composite compacted from a powdery material and at least one solid part. In one embodiment, it is provided that the powder material and the solid part are comprised of the same alloy. In a preferred embodiment, it is provided that a powder metal part exhibits shrinkage during sintering which is greater than or equal to a shrinkage of the solid part, wherein normally the solid part does not contract during sintering. In another embodiment, the shrinkage of the powder metal part during sintering is greater than that of the solid part, preferably such that the powder metal part and the solid part form a pressfit with the boundary interfaces being preferably sintered. In another variant, the solid part forms a positive connection with the powder metal part. In particular, the solid part may have a thread, which can be configured as an internal or external thread; thus, a fully sintered part made of a composite part includes a thread; for example, without undergoing any further processing step. Still other embodiments provide differing geometries for the solid part. For example, the solid part may be configured as a sheet metal, pin, bolt, tap, shaft, nut, threaded rod, fitted key and/or bearing. Preferably, any geometry is suitable that is able to accommodate the powdery material or the powder metal part. Also, in another embodiment, it is provided that multiple solid parts are arranged in a composite part. Another variant provides for at least one solid part being disposed in more than one powder metal part, in particular, bonding the latter.

The aforementioned embodiments show that a composite part made and sintered in accordance with the present invention has both the advantages of a solid part, which can be an especially low-priced purchased part, and the advantages of a sintered part. If the composite part is produced in accordance with the above described method, the costs of production are substantially less and the bond between solid part and powder metal part is substantially more reliable than is the case with methods known in the prior art, especially when the solid parts are inserted at a later stage.

These and still other advantages of the invention will be apparent from the detailed description and drawings. What follows is merely a description of some preferred embodiments of the present invention. To assess the full scope of the invention, the claims should be looked to as these preferred embodiments are not intended to be the only embodiments within the scope of the claims.

### BRIEF DESCRIPTION OF THE DRAWINGS

Further advantageous embodiments are presented in the drawings below. However, modifications shown therein are not to be construed as limiting, rather the features described therein may themselves be combined; and they may be combined with the features described above to constitute additional embodiments. Furthermore, it is noted that the reference numerals indicated in the description of the figures do not limit the scope of protection of the present invention; but they refer solely to the exemplary embodiments shown in the figures. In the following, like parts or parts with like function are identified by the same reference numerals. In the drawings:

FIG. 1 shows in schematic sequence the introduction of a solid part into a powdery material during compaction;

FIG. 2 shows in schematic sequence the introduction of a solid part into a powdery material after the powdery material has been compacted;

FIG. 3 is a micro-section of an inserted threaded pin;

FIG. 4 is a micro-section of an inserted steel pin;

FIG. 5 shows exemplary embodiments of composite parts.

### DETAILED DESCRIPTION OF THE PREFERRED EMBODIMENTS

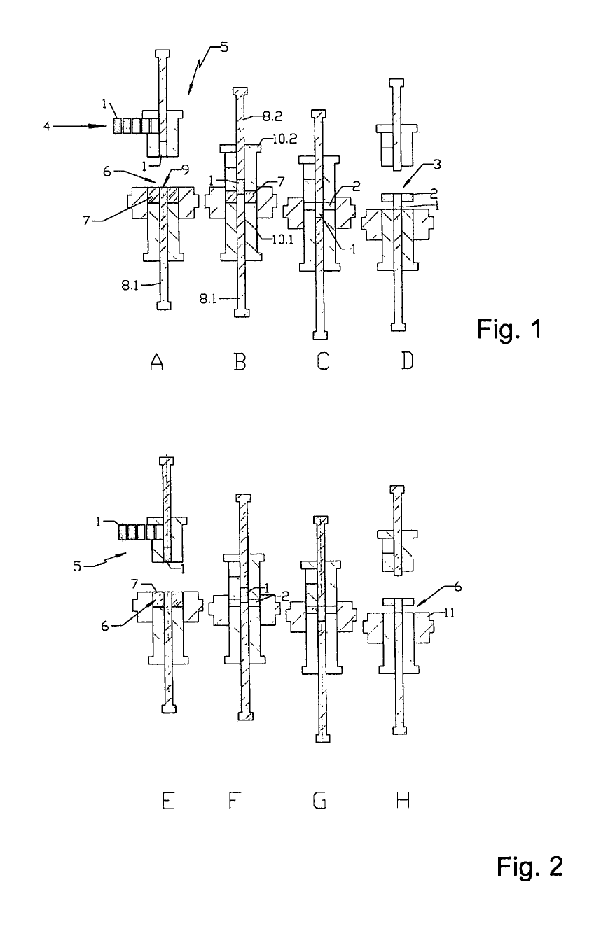

FIG. 1 shows a sequence of process steps A to D, in which a solid part 1 is bonded with a powder metal part 2 in order to form a composite part 3. In step A, a solid part 1 is inserted, preferably via an automatic feed 4, into the tool 5 of a press. The press is simplified herein for the sake of clarity and represented only by the pressing tool 5. In addition, a working chamber 6 of the pressing tool 5 is filled with a powdery material 7. A transfer punch 8.1 keeps a joining space 9 in the working chamber 6 free around which the powdery material 7 is at least partially filled in.

In step B, a first pressing punch 10.1 and a second pressing punch 10.2 are closed, thereby compacting the powdery material 7. At the same time, the solid part 1 is transferred into the powdery material 7 using the transfer punch 8.1 and the joining punch 8.2. In particular, a pressure is applied by the transfer punch 8.1 and the joining punch 8.2 to the solid part 1 in order to hold the solid part 1. Preferably, the solid part 1 is not plastically deformed by the pressure; and further, it is preferable if the solid part 1 is elastically deformed in the direction of force by less than 0.05% of its dimension.

In step C of FIG. 1, the transfer of the solid part 1 and compaction of the powdery material 7 to a non-sintered powder metal part 2—referred to hereinafter as green composite 2—is completed. In particular, the transfer and/or compaction of the powdery material is regulated by a path control or controlled by a distance control.

In step of FIG. 1, the finished composite part 3 is removed from the mold. Processing and sintering of the composite part can be accomplished in additional steps. In particular, provision is made for calibrating, at least partially, the sintered composite part.

A further embodiment provides that in step B, that is, when the solid part 1 is transferred into the powdery material 7, no compaction, or only insubstantial compaction of the powdery material 7 takes place. Insubstantial compaction is understood to mean compaction that is less than 80%, preferably less than 60%, of the envisioned thickness of the green composite 2.

FIG. 2 shows a variant for producing a green composite 3 in which a solid part 1 is fed in a first step E to a press 5 and the working chamber 6 is filled with a powdery material 7.

In a second step F, the powdery material 7 is compacted into a green composite 2, in particular, the material 7 is compacted to about 60% to 100% of the envisioned thickness of the green compact 2 in step F. In addition, the solid part 1 is transferred into the green composite 2, wherein in one embodiment compaction of the green composite 2 is interrupted. In another embodiment the solid part 1 is fed during compaction of the green composite 2 or after desired compaction of the green composite 2.

In step G, final compaction of the green composite 2 is carried out, if not already previously carried out in step F. In addition, transfer of the solid part 1 into the green composite 2 is completed. In the final step H, the finished composite part 3 is removed from the mold by, for example, being pressed out of the working chamber 6 using the transfer punch 8.1. In another embodiment it is provided that the pressing punch 10.1 moves the composite part out of the working chamber 6. In a further variant, a′die 11 surrounding the working chamber 6 is displaced in such a way as to lay the composite part open allowing it to be removed from the press.

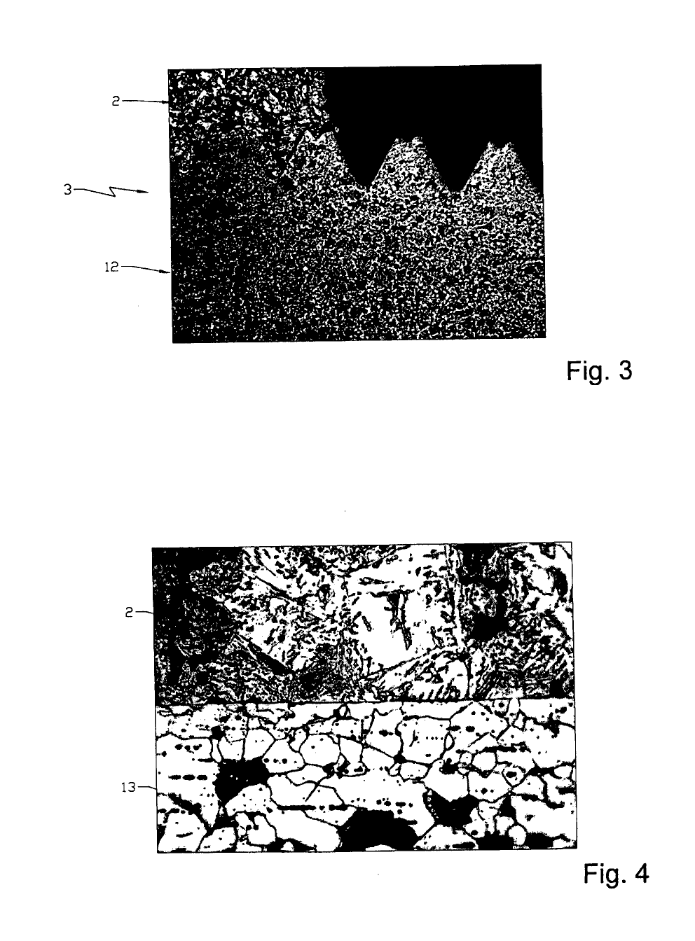

FIG. 3 shows an etched micro-section of a sintered composite part 3 comprising a burnished threaded pin 12 around which a powder metal part 2 has been pressed. The threaded pin 12 was not clean blasted prior to being joined. It can be seen that, as a result of the compaction of the green composite, powdery material 7 has penetrated into the threads of the threaded pin 12, thereby producing a dimensionally stable connection between the threaded pin and the powder metal part.

FIG. 4 shows a micro-section of a steel pin 13 compressed in a powder metal part 2. The composite part was sintered at a temperature of 1250° Celsius. Sintering with granular overlap is not visible here; however, this type of joining provides an excellent mechanical contact between the powder metal part 2 and the steel pin 13.

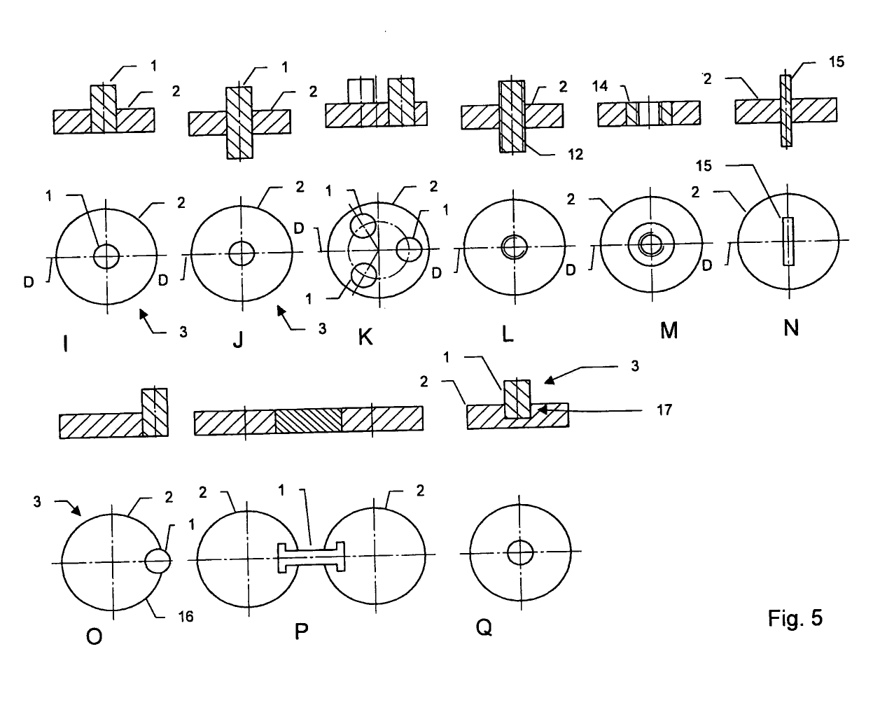

FIG. 5 shows, schematically, a variety of non-limiting embodiments of a composite part 3. In particular, geometries of the solid part 1 and/or of the powder metal part 2 may differ from the embodiments shown herein. Each upper sectional view of the respective embodiment is a cross-section through a diameter D of the composite part 3.

The embodiment I shows how the solid part 1 projects above the powder metal part 2 on one side. In the embodiment J the solid part 1 can be seen as projecting beyond the powder metal part 2 on both sides. The embodiment K shows a composite part 3 having three solid parts 1, wherein the embodiment shown here is not to be construed as limiting; rather, other variants provide for two solid parts 1. Another embodiment provides for more than three solid parts 1 in the composite part 3.

Embodiment L shows a threaded pin 12 which has been pressed into a powder metal part 2. Variant M shows a nut 14 incorporated in the powder metal part 2. In particular, it is provided that a solid part with any geometry is incorporated in by an interior thread into the powder metal part. Preferably, a standard nut, for example, a hexagonal nut is incorporated in the powder metal part.

Embodiment N shows a stamping 15 pressed into the powder metal part 2. In another variant a cast, forged or sintered solid part 1 is incorporated in the powder metal part 2.

Version O shows a composite part 3 in which a solid part 1 projects at a surface 16 orthogonally relative to the direction of pressing of the green composite 2. In another variant P, two powder metal parts 2 are pressed in one work step and bonded using at least one solid part 1.

Variant Q shows a composite part 3 with a solid part 1 that does not completely penetrate the powder metal part 2. This is achieved, in particular, when the solid part 1 is transferred into the powdery material without reserving a joining space. Thus, during joining the powdery material is displaced by the solid part 1. In an embodiment, not shown herein, the solid part 1 is at least partially tapered at least in one end region 17, specifically at the end which is inserted in the powdery material in order to facilitate displacement of the powdery material.

In particular, it is provided that the exemplary embodiments of the composite part 3 of FIG. 5 can themselves be combined with each other and/or combined with embodiments described above.

It should be appreciated that various other modifications and variations to the preferred embodiments can be made within the spirit and scope of the invention. Therefore, the invention should not be limited to the described embodiments. To ascertain the full scope of the invention, the following claims should be referenced.

What is claimed is:

1. A method for producing a composite part having at least one powder metal part compacted from a powdery material and at least one solid part, the method comprising compacting the powdery material to form a powder metal part inside a working chamber of a tool of a press, and at least partially feeding the solid part to the working chamber in the same working cycle of the press to produce the composite part within one working cycle of the press.

2. The method according to claim 1, wherein, in a first step of the working cycle, the solid part is fed into the powdery material in the working chamber and, in a second step, the powdery material is compacted to form the powder metal part.

3. The method according to claim 1, wherein, in a first step of the working cycle, the powdery material in the working chamber is compacted to form the powder metal part and, in a second step, the solid part is fed into the powder metal part in the working chamber.

4. The method according to claim 1, wherein the solid part is fed into the working chamber while the powdery material is compacted to form the powder metal part.

5. The method according to claim 1, wherein the solid part is transferred into the working chamber in such a way that, after the working step, the solid part projects from one surface of the powder metal part.

6. The method according to claim 1, wherein the solid part is surface-treated before being introduced into the press.

7. The method according to claim 1, further comprising the step of sintering the composite part.

8. A press for compacting and joining a composite part, the press comprising at least one tool for creation of a working chamber, and further comprising at least one pressing punch and at least one joining punch.

9. The press according to claim 8, wherein the at least one pressing punch is adapted to compact a green composite from a powdery material within the working chamber.

10. The press according to claim 8, wherein at least one of the at least one joining punch and a transfer punch is adapted to transfer a solid part into the working chamber.

11. The press according to claim 8, wherein the transfer punch is configured to reserve a joining space in the working chamber into which the solid part is transferable.

12. The press according to claim 8, wherein the press includes a control device that controls at least one transfer of the solid part into the working chamber.

13. A computer program product for a press having a tool having a working chamber and at least one pressing punch as well as at least one joining punch, wherein a method is implemented in the computer program product by which the joining punch is actuated in such a way that it transfers a solid part into a working chamber filled at least partially with a powdery material.

14. A computer program product according to claim 13, wherein a transfer punch is actuated in such a way that the transfer punch reserves a joining space in the working chamber, and said joining space is at least partially filled with a powdery material and into which a solid part is transferred by the joining punch.

15. The computer program product according to claim 13, wherein after a transfer of the solid part into the working chamber, the pressing punch is actuated so that the powdery material is compacted to form a powder metal part.

16. The computer program product according to claim 13, wherein, prior to a transfer of the solid part into the working chamber, the pressing punch is actuated so that the powdery material is compacted to form a powder metal part.

17. The computer program product according to claim 13, wherein at least one of the punches are moved using a distance control.

18. The computer program product according to claim 13, wherein the pressing punches are actuated in such a way that the punching presses exert a predefined force upon the powdery material or perform a predefined work on the powdery material.

19. A composite part comprising at least one powder metal part compacted from a powdery material and at least one solid part.

20. The composite part according to claim 19, wherein the powdery material and the solid part are comprised of the same alloy.

21. The composite part according to claim 19, wherein the solid part and the powdery material are comprised of different alloys.

22. The composite part according to claim 19, wherein the powder metal part undergoes a shrinkage during sintering which is greater than or equal to a shrinkage of the solid part.

23. The composite part according to claim 19, wherein the solid part includes a thread.

24. The composite part according to claim 19, wherein the solid part is materially bonded with the powder metal part in a sintering process.

25. The composite part according to claim 19, wherein the solid part and the powder metal part form a positive connection.
